(19) United States
(12) Patent Application Publication
(10) Pub. No.: US 2015/0236522 A1
(43) Pub. Date: Aug. 20, 2015

(54) USB CHARGING SYSTEM WITH VARIABLE CHARGING VOLTAGE, CHARGER AND SMART TERMINAL

(71) Applicant: HUIZHOU TCL MOBILE COMMUNICATION CO., LTD., HUIZHOU, GD (CN)

(72) Inventors: Shiqing Zhao, Huizhou (CN); Dexiang Edward Luo, Huizhou (CN); Xuelong Hu, Huizhou (CN)

(21) Appl. No.: 14/419,196

(22) PCT Filed: Aug. 6, 2013
(86) PCT No.: PCT/CN2013/080885

§ 371 Date: Feb. 2, 2015

(30) Foreign Application Priority Data
Apr. 12, 2013 (CN) 2013101264687.3

(51) Int. Cl. H02J 7/00

(52) U.S. Cl. CPC H02J 7/007; H02J 7/0052; H02J 2007/0062

(57) ABSTRACT

A charger includes a first universal serial bus (USB) interface; an AC/DC module, a gating module, and a first control module. The AC/DC module is configured to convert an AC voltage to a DC voltage, and output at least two charging voltages. The gating module is configured to selectively connect to an output end corresponding to the charging voltages. The first control module is configured to control, according to level states of a positive data line end and a negative data line end of the first USB interface, the gating module to select an output end.

### TECHNICAL FIELD

The present disclosure relates to the field of charging technologies, and more particularly to a universal serial bus (USB) charging system with a variable charging voltage, a charger, and a smart terminal.

### BACKGROUND

Smart phones, smart tablet computers and other smart terminals are more and more popular with young consumers, and at present, almost everyone has a smart terminal. In order to improve user experience, display screens of smart terminals become larger, with more powerful functions, and a higher CPU processing speed, but all these changes cause the smart terminals to consume more power. In order to solve the power consumption problem, an approach of increasing battery capacity is generally adopted at present, to extend standby time of the smart terminals. However, another problem may arise: due to an increase in the battery capacity, charging time becomes longer, which also leads to poor user experience.

In view of this, the present invention provides a USB charging system with a variable charging voltage, a charger, and a smart terminal.

### SUMMARY

In view of the deficiencies of the prior art, an objective of the present invention is to provide a USB charging system with a variable charging voltage, a charger, and a smart terminal, so as to solve the problem in the prior art that charging time of a battery is long.

In order to achieve the foregoing objective, the present invention uses the following technical solutions:

A charger includes a first USB interface; an AC/DC module, configured to convert an AC voltage to a DC voltage, and output at least two charging voltages; a gating module, configured to selectively connect to an output end corresponding to the charging voltages; and a first control module, configured to control, according to level states of a positive data line end and a negative data line end of the first USB interface, the gating module to select the output end.

In another embodiment of a charger, the AC/DC module is connected to the first control module, the AC/DC module is connected to a power supply end of the first USB interface through the gating module, and the first control module is connected to the gating module, and the positive data line end, the negative data line end, and an identification end of the first USB interface.

In a further embodiment of a charger, the AC/DC module includes a 5V charging voltage output end; and the first control module is further configured to control the gating module to connect to the 5V charging voltage output end when the positive data line end and the negative data line end are both at a low level.

In yet another embodiment of a charger, the AC/DC module includes a 9V charging voltage output end; and the first control module is further configured to control the gating module to connect to the 9V charging voltage output end when the positive data line end is at a high level and the negative data line end is at a low level.

In yet a further embodiment of a charger, the AC/DC module includes a 12V charging voltage output end; and the first control module is further configured to control the gating module to connect to the 12V charging voltage output end when the positive data line end is at a low level and the negative data line end is at a high level.

In another embodiment of a charger, the AC/DC module includes a 15V charging voltage output end; and the first control module is further configured to control the gating module to connect to the 15V charging voltage output end when the positive data line end and the negative data line end are both at a high level.

In a further embodiment of a charger, the gating module is a single-pole multi-throw analog switch.

In yet another embodiment, a smart terminal includes a battery; a second USB interface; a charge management module, configured to charge the battery and control a charging voltage curve; and a second control module, configured to monitor a charging signal and control level states of a positive data line end and a negative data line end of the second USB interface according to the charging signal.

In yet a further embodiment, the charge management module is connected to a power supply end of the second USB interface, the second control module, and a positive terminal of the battery, and a negative terminal of the battery is grounded; and the second control module is connected to the charge management module, and the positive data line end, the negative data line end, and an identification end of the second USB interface.

In another embodiment of a smart terminal, the charging signal includes battery capacity and a charging current output by the charge management module.

In a further embodiment of a smart terminal, the smart terminal is either a smart phone or a tablet computer.

In yet another embodiment, a charging system includes a charger and a smart terminal, where the charger includes: a first USB interface; an AC/DC module, configured to convert an AC voltage to a DC voltage, and output at least two charging voltages; a gating module, configured to selectively connect to an output end corresponding to the charging voltages; and a first control module, configured to control, according to level states of a positive data line end and a negative data line end of the first USB interface, the gating module to select the output end; and the smart terminal includes: a battery; a second USB interface; a charge management module, configured to charge the battery and control a charging voltage curve; and a second control module, configured to monitor a charging signal and control level states of a positive data line end and a negative data line end of the second USB interface according to the charging signal.

In yet a further embodiment, a charging system further includes a USB data line, and the charger is connected to the smart terminal through the USB data line.

In another embodiment of a charging system, the charging signal includes battery capacity and a charging current output by the charge management module.

In yet another embodiment of a charging system, the AC/DC module includes a 5V charging voltage output end, a 9V charging voltage output end, a 12V charging voltage output end, and a 15V charging voltage output end, where when the positive data line end and the negative data line end are both at a low level, the first control module is configured to control the gating module to connect to the 5V charging voltage output end; when the positive data line end is at a high level and the negative data line end is at a low level, the first control module is configured to control the gating module to connect to the 9V charging voltage output end; when the positive data line end is at a low level and the negative data line end is at a high level, the first control module is configured to control the gating module to connect to the 12V charging voltage output end; and when the positive data line end and the negative data line end are both at a high level, the first control module is configured to control the gating module to connect to the 15V charging voltage output end.

In a further embodiment of a charging system, the gating module is a single-pole multi-throw analog switch.

In yet a further embodiment of a charging system, the AC/DC module is connected to the first control module, the AC/DC module is connected to a power supply end of the first USB interface through the gating module, and the first control module is connected to the gating module, and the positive data line end, the negative data line end, and an identification end of the first USB interface.

Compared with the prior art, in the charging system, the charger, and the smart terminal provided in the present disclosure, at the side of the charger, the gating module is controlled, according to high and low level states of a D+ end and a D− end of a USB interface, to select a corresponding charging voltage end on the AC/DC module, which increases output power of the charger while a charging current output by the charger is constant; at the side of the smart terminal, level states of a D+ end and a D− end of a USB interface thereof are controlled by the second control module, to instruct the charger to output a corresponding voltage, and a charging voltage curve is controlled to be constant by the charge management module, thereby greatly shortening charging time of the battery by increasing input power.

### BRIEF DESCRIPTION OF THE DRAWINGS

FIG. 1 depicts a structural block diagram of a charger in a USB charging system with a variable charging voltage according to the present invention; and

FIG. 2 depicts a structural block diagram of a smart terminal in a USB charging system with a variable charging voltage according to the present invention.

### DETAILED DESCRIPTION

A conventional USB charging voltage may be +5V, and therefore, charging time of a battery may be fixed because a charging voltage and a charging current output by a charger are fixed. A voltage of a VBUS end (power supply end) of a standard USB physical interface may be +5V. Because a power supply current of a standard USB physical interface may be limited by a USB connector, a connecting wire, and wiring of a printed circuit board (PCB), a maximum value of the power supply current of the standard USB physical interface may be limited, and a nominal current may be generally 500 mA.

In order to improve charging efficiency, a USB charging system with a variable charging voltage, a charger, and a smart terminal, are provided to improve charging power and efficiency by means of a variable charging voltage, so as to shorten charging time.

In order to make the objectives, technical solutions and effects of the charging system, the charger, and the smart terminal of the present disclosure clearer, the charging system, the charger, and the smart terminal are described in detail below with reference to the accompanying drawings and specific embodiments. It should be understood that specific embodiments described herein are for illustrative purposes, and are not intended to limit the scope of protection in any way.

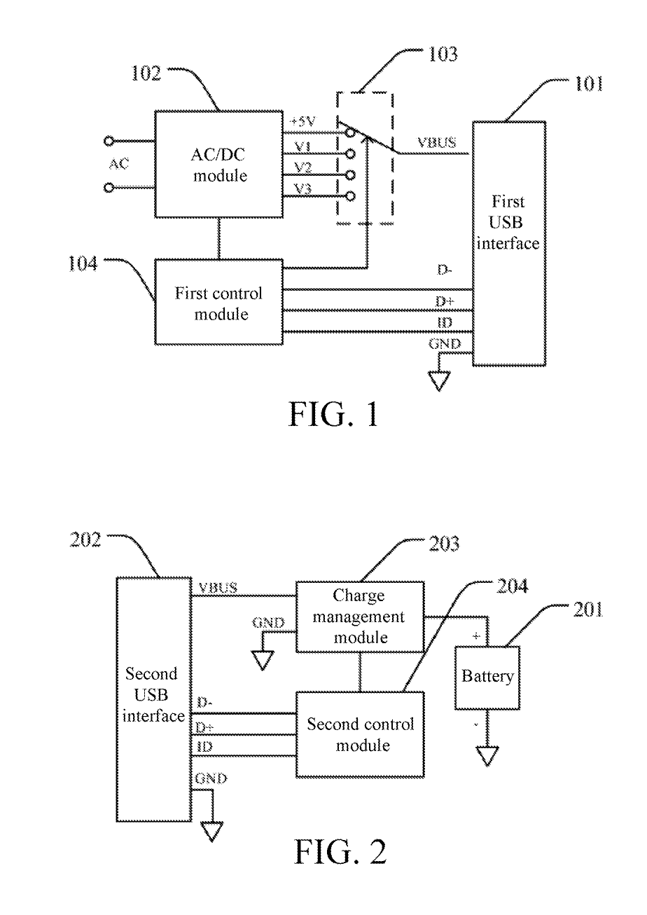

Referring to FIG. 1 a structural block diagram of a charger in a USB charging system with a variable charging voltage is depicted. With additional reference to FIG. 2, a structural block diagram of a smart terminal in a USB charging system with a variable charging voltage is depicted.

The USB charging system with a variable charging voltage may include a charger and a smart terminal. As shown in FIG. 1, the charger may include a first USB interface 101, an AC/DC (alternating current to direct current) module 102, a gating module 103 and a first control module 104. The first USB interface 101 may include a VBUS end, a D+ end (positive data line end), a D− end (negative data line end), an ID end (identification end) and a GND end (grounding end), where the GND end of the first USB interface 101 may be grounded.

The AC/DC module 102 is connected to a power plug (not shown) and the first control module 104, and may be further connected to the VBUS end of the first USB interface 101 through the gating module 103, and may be configured to convert an AC voltage to a DC voltage, and output at least two charging voltages. In the two charging voltages, one may be a voltage of +5V, and the other may be a DC voltage greater than 5V.

The gating module 103 may be a single-pole multi-throw analog switch, configured to selectively connect to a charging voltage output end of the AC/DC module 102. The first control module 104 may be connected to the gating module 103, and the D+ end, the D− end, and the ID end of the first USB interface 101, and may be configured to control, according to level states of the D+ end and the D− end of the first USB interface 101, the gating module 103 to selectively connect to a corresponding charging voltage output end.

As shown in FIG. 2, the smart terminal may include a battery 201, a second USB interface 202, a charge management module 203, and a second control module 204. The second USB interface 202 may include a VBUS end, a D+ end, a D− end, an ID end, and a GND end, and the GND end of the second USB interface 202 may be grounded.

The charge management module 203 may be connected to the VBUS end of the second USB interface 202, the second control module 204, and a positive terminal of the battery 201, and a negative terminal of the battery 201 is grounded. The charge management module 203 may be configured to charge the battery 201 and control a charging voltage curve, and specifically, control the charging voltage curve to be constant when the battery 201 is charged.

The second control module 204 may be connected to the charge management module 203, and the D+ end, the D− end, and the ID end of the second USB interface 202, and may be configured to monitor a charging signal and control level states of the D+ end and the D− end of the second USB interface 202 according to the charging signal. The charging signal may include battery capacity and/or a charging current output by the charge management module.

During charging, the USB charging system with a variable charging voltage may include a USB data line, and the charger may be connected to the smart terminal through the USB data line. In a specific example implementation, the AC/DC module 102 may include four charging voltage output ends, which may be, for example, a 5V charging voltage output end, a 9V charging voltage output end V1, a 12V charging voltage output end V2, and a 15V charging voltage output end V3, respectively. In a default state, the first control module 104 may control the gating module 103 to connect to the 5V charging voltage output end, so as to be compatible with a universal charger. Certainly, the number of output voltage ends and voltage values of the AC/DC module 102 may also be other numbers and values, which may be specifically set according to the battery capacity.

An AC/DC module 102 may include four charging voltage output ends, and the gating module 103 may be a single-pole four-throw analog switch, correspondingly, such that different charging voltage output ends can be selected. A selection end of the single-pole four-throw analog switch may be connected to the first USB interface 101, and a fixed end thereof may be connected to the 5V charging voltage output end, the 9V charging voltage output end V1, the 12V charging voltage output end V2, and the 15V charging voltage output end V3 of the AC/DC module 102. A control end of the single-pole four-throw analog switch may be connected to the first control module 104.

A variable charging voltage may be achieved by using a standard USB physical interface, and may improve output power of the charger by increasing the charging voltage while ensuring that a charging current of the charger is within a nominal current range. The increased charging voltage of the charger can be used, for example, to control, according to handshake and protocol conditions of the smart terminal and the charger, the selection end of the single-pole four-throw analog switch to connect to the corresponding charging voltage output end, such that a voltage on VBUS of the first USB interface 101 can be a voltage other than +5V, or to be precise, a voltage higher than +5V, for example, +9V, +12V, or +15V.

The charging voltage of the charger may be increased, and in the case that the charging current is constant, according to the power calculation formula: P=U×I, where P denotes power, U denotes voltage, and I denotes a charging current output by the charger, in the case that the charging current I is constant, as the voltage output by the charger is increased, the output power P may be proportionally increased correspondingly, for example, the voltage may be doubled, and on the premise that the current is constant, the power is also doubled.

The voltage provided by the charger may pass through the charge management module 203 and then may be used to charge the battery 201. According to the law of conservation of energy, due to an increase in input power, after the voltage passes through the charge management module 203, because a charging curve parameter and conversion efficiency of the charge management module 203 may be unchanged, the charging current applied to the battery 201 may increase, and the charging time may be shortened due to the increase in the charging current of the battery 201.

According to the law of conservation of energy, the output power of the charger (i.e., input power of the smart terminal) may be P1=U1×I1, where P1 denotes the output power of the charger (equal to the input power of the smart terminal), U1 denotes the output voltage of the charger (equal to the input voltage of the smart terminal), and I1 denotes the output current of the charger (equal to the input current of the smart terminal). As output of the charger may be connected to the charge management module 203 of the smart terminal, the input power of the charge management module 203 may be equal to the output power of the charger, that may be, P1=U1×I1.

During charging and power supply, after charge management, and voltage conversion and current conversion on DC/DC voltage, output power of a charge management unit may be P2=U2×I2, where P2 denotes the output power of the charge management module 203, and U2 denotes the output voltage of the charge management module 203, that may be, the charging voltage of the battery 201, and the charging voltage may be controlled by the second control module 204 according to a charging voltage curve, which may be executed by the charge management module 203. I2 denotes the output current of the charge management module 203, that may be, the charging current of the battery 201, and the charging current may be controlled by the second control module 204 according to a charging current curve, which is executed by the charge management module 203.

According to the law of conservation of energy, assuming that energy conversion efficiency of the charge management module 203 is η, P2=P1×η; it can be seen from the formula that, when the conversion efficiency η is constant (as the conversion efficiency η of the charge management module 203 may be basically unchanged or changes slightly in the case of high voltage input and in the case of low voltage input), and therefore, when the input power of the charge management module 203 is increased, the output power of the charge management module 203 may also proportionally increase, that is, the charging power may be proportionally increased.

If the output voltage U1 of the charger is increased and the output current I1 is increased, the output power P1 of the charger may also increase. When the output current of the charger is constant, if the output voltage U1 of the charger is increased, the output power P1 of the charger may be also increase, while the output power of the charger may be equal to the input power of the charge management module 203. When the conversion efficiency η of the charge management module 203 is constant, the input power can be increased by increasing the input voltage. It can be known according to the relation P2=P1×η between the output power P2 and input power P1 of the charge management module 203 that, when the conversion efficiency η is constant, if the input power of the charge management module 203 is increased, the output power thereof may also proportionally increase. Input power to a smart terminal may be increased by increasing an input voltage, which is entirely different from the traditional method for increasing power by increasing an output current while keeping a constant input voltage.

After the charger is connected to the smart terminal, an initial voltage of the VBUS end of the charger may be +5V, and after the smart terminal detects, through the VBUS end, the connection of the charger, the smart terminal may detect a level state of D+/D−. Within a first hundreds of milliseconds after the charger is connected to the terminal, a level matching, voltage to be output by the charger may be output through D+/D− and may be held, where the holding time may be several hundred milliseconds. After detecting the level of D+/D−, the smart terminal may wait until the level of D+/D− becomes a low level. At this time, the D+/D− end of the charger may change to being an input from being an output, and the smart terminal may send an acknowledgment signal to the charger according to the received D+/D− level, where the acknowledgement signal may also be transmitted through D+/D−. At this time, D+/D− of the USB data line may be a time division multiplexing bidirectional signal line. If the smart terminal detects that the level of D+/D− is a preset protocol level, the smart terminal may wait until the level of D+/D− becomes a low level, and at this time, the D+/D− end of the charger may change to being an input from being an output, and the smart terminal may send an acknowledgment signal to the charger according to the received D+/D− level, where the acknowledgement signal may also be transmitted through D+/D−. The smart terminal may output a corresponding level to the charger on the D+/D− end, and after the charger detects the acknowledgement signal returned by the smart terminal, the charger may indicate that a handshake between the charger and the smart terminal succeeded, and then the charger may start to output a predetermined voltage to the smart terminal. Setting of the charging voltage, control instructions and the like may be achieved by using a D+/D− signal of the USB interface, which may simplify the hardware circuit, and/or may save electronic components.

In the USB charging system with a variable charging voltage, setting of the charging voltage, control instructions and the like may be achieved by using a D+/D− signal of the USB interface. After the handshake between the charger and the smart terminal succeeds, the charger may start to charge the battery 201. During charging, states of the battery 201 and the charge management module 203 may be monitored by the second control module 204, that is, capacity of the battery 201 and a charging current output by the charge management module 203 may be monitored by the second control module 204; the D+ end and the D− end of the second USB interface 202 may be controlled, according to the states of the battery 201 and the charge management module 203, to correspondingly output high-level and low-level signals.

At this time, as the second USB interface 202 may be electrically connected to the first USB interface 101, level states of the D+ ends and D− ends of the two USB interfaces may be the same. In order to increase charging efficiency, the first control module 104 may control, according to the level states of the D+ end and the D− end of the first USB interface 101, the gating module 103 to connect to the corresponding charging voltage output end, that is, a voltage output end, which may be higher than 5V, of the AC/DC module 102 can be selected.

During a specific example implementation, when the D+ end and the D− end of the first USB interface 101 are both at a low level, the first control module 104 may control the gating module 103 to connect to the 5V charging voltage output end of the AC/DC module 102. When the D+ end of the first USB interface 101 is at a high level and the D− end is at a low level, the first control module 104 may control the gating module 103 to connect to the 9V charging voltage output end V1 of the AC/DC module 102. When the D+ end of the first USB interface 101 is at a low level and the D− end is at a high level, the first control module 104 may control the gating module 103 to connect to the 12V charging voltage output end V2 of the AC/DC module 102. When the D+ end and the D− end of the first USB interface 101 are both at a high level, the first control module 104 may control the gating module 103 to connect to the 15V charging voltage output end V3 of the AC/DC module 102.

The second control module 204 may determine setting of high and/or low level states of the D+ end and the D− end of the second USB interface 202 according to actual situations of the battery 201. When the capacity of the battery 201 is high (for example, when the capacity exceeds first capacity) and a great charging current (which needs to be greater than a first charging current) is required for charging, the second control module 204 may set both the D+ end and the D− end of the second USB interface 202 to a high level, and may instruct the charger to output a charging voltage of 15V to charge the battery 201. If the capacity of the battery 201 of the smart terminal is moderate (for example, between the first capacity and second capacity) and a moderate charging current (for example, between the first charging current and a second charging current) is required for charging, the second control module 204 may set the D+ end of the second USB interface 202 to a low level and the D− end to a high level, and may instruct the charger to output a charging voltage of 12V to charge the battery 201. If the capacity of the battery 201 is low (for example, between the second capacity and third capacity) and a small charging current (for example, between the second charging current and a third charging current) is required for charging, the second control module 204 may set the D+ end of the second USB interface 202 to a high level and the D− end to a low level, and may instruct the charger to output a charging voltage of 9V to charge the battery 201. If the capacity of the battery 201 is low (for example, less than the third capacity) and a small charging current (for example, less than the third charging current) is required for charging, the second control module 204 may set both the D+ end and the D− end of the second USB interface 202 to a low level, and may instruct the charger to output a charging voltage of 5V to charge the battery 201.

Through the above voltage setting, in the case of a constant current, input power of the smart terminal may be proportionally increased; the charge management module 203 may ensure that the charging current is increased on the premise that the charging voltage curve is constant (that is, the charging voltage is constant), so that charging power may be increased, thereby shortening the charging time. In addition, as the charging voltage curve is unchanged, security of the battery 201 may not be affected no matter which voltage is used to charge the battery 201.

Based on the USB charging system with a variable charging voltage, a smart terminal may be provided, including a smart phone or a tablet computer, which can control, according to battery capacity and/or values of a charging current, a D+ end and a D− end of a USB interface thereof to output corresponding high-level and low-level signals, so as to instruct the charger to output corresponding charging voltages.

At a side of the charger, the gating module may be controlled, according to high and low level states of a D+ end and a D− end of a USB interface, to select a corresponding charging voltage end on the AC/DC module, which may increase output power of the charger while a charging current output by the charger may be constant. At the side of a smart terminal, a second control module may control level states of a D+ end and/or a D− end of a USB interface thereof, to instruct the charger to output a corresponding voltage, and a charging voltage curve may be controlled to be constant by a charge management module, thereby greatly shortening charging time of the battery by increasing input power.

It should be understood that, persons of ordinary skill in the art can make equivalent replacements or variations according to the technical solutions and inventive concepts of the present disclosure, and all the variations or replacements shall fall with the scope defined by the appended claims.

1. The charger according to claim 4, wherein
the gating module is a single-pole multi-throw analog switch, and
the AC/DC module comprises a 5V charging voltage output end, a 9V charging voltage output end, a 12V charging voltage output end, and a 15V charging voltage output end;
when the positive data line end and the negative data line end are both at a low level, the first control module is configured to control the gating module to connect to the 5V charging voltage output end;
when the positive data line end is a at high level and the negative data line end is at a low level, the first control module is configured to control the gating module to connect to the 9V charging voltage output end;
when the positive data line end is at a low level and the negative data line end is at a high level, the first control module is configured to control the gating module to connect to the 12V charging voltage output end; and
when the positive data line end and the negative data line end are both at a high level, the first control module is configured to control the gating module to connect to the 15V charging voltage output end.

2. The charger according to claim 1, wherein the AC/DC module is connected to the first control module, and the AC/DC module is connected to a power supply end of the first USB interface through the gating module.

3. The charger according to claim 1, wherein the first control module is connected to the gating module, the positive data line end, the negative data line end, and an identification end of the first USB interface.

4. A charger, comprising:
a first universal serial bus (USB) interface;
an AC/DC module, configured to convert an AC voltage to a DC voltage, and output at least two charging voltages;
a gating module, configured to selectively connect to an output end corresponding to the charging voltages; and
a first control module, configured to control, according to level states of a positive data line end and a negative data line end of the first USB interface, the gating module to select the output end.

5. The charger according to claim 4, wherein the AC/DC module is connected to the first control module, the AC/DC module is connected to a power supply end of the first USB interface through the gating module; and the first control module is connected to the gating module, the positive data line end, the negative data line end, and an identification end of the first USB interface.

6. The charger according to claim 5, wherein the AC/DC module comprises a 5V charging voltage output end; and
the first control module is further configured to control the gating module to connect to the 5V charging voltage output end when the positive data line end and the negative data line end are both at a low level.

7. The charger according to claim 5, wherein the AC/DC module comprises a 9V charging voltage output end; and
the first control module is further configured to control the gating module to connect to the 9V charging voltage output end when the positive data line end is at a high level and the negative data line end is at a low level.

8. The charger according to claim 5, wherein the AC/DC module comprises a 12V charging voltage output end; and
the first control module is further configured to control the gating module to connect to the 12V charging voltage output end when the positive data line end is at a low level and the negative data line end is at a high level.

9. The charger according to claim 5, wherein the AC/DC module comprises a 15V charging voltage output end; and
the first control module is further configured to control the gating module to connect to the 15V charging voltage output end when the positive data line end and the negative data line end are both at a high level.

10. The charger according to claim 4, wherein the gating module is a single-pole multi-throw analog switch.

11. A smart terminal, comprising:
a battery;
a second universal serial bus (USB) interface;
a charge management module, configured to charge the battery and control a charging voltage curve; and
a second control module, configured to monitor a charging signal and control level states of a positive data line end and a negative data line end of the second USB interface according to the charging signal.

12. The smart terminal according to claim 11, wherein the charge management module is connected to a power supply end of the second USB interface, the second control module, and a positive terminal of the battery, and a negative terminal of the battery is grounded; and
the second control module is connected to the charge management module, and the positive data line end, the negative data line end, and an identification end of the second USB interface.

13. The smart terminal according to claim 11, wherein the charging signal comprises battery capacity and a charging current output by the charge management module.

14. The smart terminal according to claim 11, wherein the smart terminal is either a smart phone or a tablet computer.

15. A charging system, comprising a charger and a smart terminal, wherein the charger comprises:
a first universal serial bus (USB) interface;
an AC/DC module, configured to convert an AC voltage to a DC voltage, and output at least two charging voltages;
a gating module, configured to selectively connect to an output end corresponding to the charging voltages; and
a first control module, configured to control, according to level states of a positive data line end and a negative data line end of the first USB interface, the gating module to select the output end; and
the smart terminal comprises:
a battery;
a second USB interface;
a charge management module, configured to charge the battery and control a charging voltage curve; and
a second control module, configured to monitor a charging signal and control level states of a positive data line end and a negative data line end of the second USB interface according to the charging signal.

16. The charging system according to claim 15, further comprising a USB data line, wherein the charger is connected to the smart terminal through the USB data line.

17. The charging system according to claim 15, wherein the charging signal comprises battery capacity and a charging current output by the charge management module.

18. The charging system according to claim 17, wherein the AC/DC module comprises a 5V charging voltage output end, a 9V charging voltage output end, a 12V charging voltage output end, and a 15V charging voltage output end;
when the positive data line end and the negative data line end are both at a low level, the first control module is configured to control the gating module to connect to the 5V charging voltage output end;
when the positive data line end is at a high level and the negative data line end is at a low level, the first control module is configured to control the gating module to connect to the 9V charging voltage output end;
when the positive data line end is at a low level and the negative data line end is at a high level, the first control module is configured to control the gating module to connect to the 12V charging voltage output end; and
when the positive data line end and the negative data line end are both at a high level, the first control module is configured to control the gating module to connect to the 15V charging voltage output end.

19. The charging system according to claim 15, wherein the gating module is a single-pole multi-throw analog switch.

20. The charging system according to claim 15, wherein the AC/DC module is connected to the first control module, the AC/DC module is connected to a power supply end of the first USB interface through the gating module, and the first control module is connected to the gating module, the positive data line end, the negative data line end, and an identification end of the first USB interface.
